(19) United States
(12) Patent Application Publication
(10) Pub. No.: US 2015/0183653 A1
(43) Pub. Date: Jul. 2, 2015

(54) METHOD FOR PREPARING ALKALI METAL CARBONATES FROM INORGANIC MATERIALS INCLUDING ALKALI METAL IONS USING ELECTROLYSIS SYSTEM

(71) Applicant: KOREA INSTITUTE OF SCIENCE AND TECHNOLOGY, Seoul (KR)

(72) Inventors: Kwang Deog JUNG, Seoul (KR); Heung Yong HA, Seoul (KR); Jun Woo OH, Seoul (KR); Sung Min LEE, Seoul (KR); Ho Yong JO, Seoul (KR)

(21) Appl. No.: 14/585,936

(22) Filed: Dec. 30, 2014

(30) Foreign Application Priority Data
Jan. 2, 2014 (KR) 10-2014-0000082

(51) Int. Cl. C01F 11/18; C22B 26/20; C25B 9/08; C22B 7/00; C25B 1/20; C25B 1/22

(52) U.S. Cl. CPC C01F 11/182; C25B 1/20; C25B 1/22; C25B 9/08; C22B 7/007; C22B 26/20

(57) ABSTRACT

The present invention relates to a method for preparing a carbonate of an alkali ion using an electrolysis system, more particularly to an improved method for preparing a carbonate of an alkali ion, including eluting an alkali ion from an inorganic material containing the alkali ion and converting the eluted alkali ion to a carbonate, using an electrolysis system which generates an eluting agent and a quick precipitating agent used for the elution of the alkali ion and the conversion to the carbonate at the same time.

### CROSS-REFERENCE TO RELATED APPLICATIONS

This application claims priority under 35 U.S.C. §119 to Korean Patent Application No. 10-2014-0000082, filed on Jan. 2, 2014, in the Korean Intellectual Property Office, the disclosure of which is incorporated herein by reference in its entirety.

### BACKGROUND

(a) Technical Field

The present invention relates to a method for preparing alkali metal carbonates using an electrolysis system, more particularly to an improved method for preparing alkali metal carbonates including eluting an alkali ion from inorganic materials containing the alkali ions and converting the eluted alkali ions to carbonates, using an electrolysis system which generates an eluting agent and a quick precipitating agent used for the elution of the alkali ions and the conversion to the carbonates at the same time.

(b) Background Art

Extreme weather caused by global warming is considered as a severe environmental problem. The main cause of the global warming is increased greenhouse gases in the atmosphere. Carbon dioxide, which is the representative greenhouse gas, is emitted in large quantities into the atmosphere as a result of fossil fuel use. To solve the environmental problem, development of a technology for dealing with carbon dioxide stably and economically is necessary.

Carbon dioxide is emitted in large quantities in thermal power stations, cement industry and petrochemical industry. Liquid or solid absorbents capable of dealing with a large quantity of carbon dioxide are used in these industries to selectively absorb or adsorb carbon dioxide included in exhaust gases. However, because of degeneration of the absorbent or the energy required to recycle the absorbent, it cost a lot to operate the process. In addition, because an additional cost is necessary to process the captured carbon dioxide, there is a limitation in industrial application.

To overcome the problem of the carbon dioxide capture technology, the ‘mineral carbonation technology’ of capturing carbon dioxide and at the same time converting it to a stable inorganic carbonate is being developed.

The mineral carbonation technology mimics the nature's carbon cycle processes, wherein carbon dioxide is carbonated and converted into a mineral and carbon dioxide released again from the mineral through weathering, by converting carbon dioxide directly or indirectly to inorganic carbonates. The mineral carbonation technology includes a direct carbonation method of directly reacting a mineral containing a carbonizable metal ion with carbon dioxide and an indirect carbonation method of eluting a metal ion from a mineral and then reacting it with carbon dioxide.

The minerals used in the mineral carbonation technology include feldspar (CaAl₂Si₂O₈), forsterite (Mg₂SiO₄), glauconite, ilmenite (FeTiO₃), listwanite (carbonated serpentinite), magnetite, olivine ((Mg,Fe)₂SiO₄), opoka, serpentine, serpentinite, talc (Mg₃Si₄Si₁₀(OH)₂), wollastonite (CaSiO₃), etc.

Since first attempted by Seifritz in 1990, carbon dioxide sequestration using the mineral carbonation technology is being studied mainly with olivine, serpentine and wollastonite.

\hat{1} Olivine:
Mg₂SiO₄+CO₂→MgCO₃+SiO₂ ΔH=−89 kJ/mol

\hat{2} Serpentine:
Mg₃SiO₅(OH)₄+3CO₂→3MgCO₃+2SiO₂+₂H₂O ΔH=−64 kJ/mol

\hat{3} Wollastonite:
CaSiO₃+CO₂→CaCO₃+SiO₂

In general, an alkali ion is eluted from a mineral and carbonated in the mineral carbonation technology. However, the carbonation of mineral costs a lot because of high energy consumption.

Therefore, the carbonation technology wherein waste resources containing alkali ions are used instead of mineral resources is drawing a lot of attentions. The carbonation of waste resources containing alkali ions is advantageous in that the reaction rate is much faster than when minerals are used and the cost of pulverizing the minerals can be saved. For example, since the fly ash generated in coal-fired power plants contains considerable amounts of calcium or magnesium ions and thus is directly carbonated easily, reaction efficiency can be enhanced. Also, waste concrete containing calcium ions in the form of 3CaO.2SiO₂.H₂O and Ca(OH)₂ can be used as a waste resource for mineral carbonation. As a carbonation technology using waste concrete, a method of synthesizing high-purity calcium carbonate by eluting calcium ions from waste concrete using a carbon dioxide solution at high pressures maintained at 0.1-3 MPa and then carbonating the same is reported. The obtained calcium carbonate is reported to have a high purity close to about 98%. The two-step mineral carbonation technology using a carbon dioxide solution is applicable not only to fly ash and waste concrete but also to steelmaking slag.

Although a process of preparing precipitated calcium carbonate (PCC) by carbonation after dissolving steelmaking slag using an acidic solvent such as acetic acid has been developed, the use of the additional solvent leads to greatly increased costs.

Meanwhile, as a method for capturing carbon dioxide, a process of preparing sodium bicarbonate (NaHCO₃) from carbon dioxide using sodium hydroxide produced from electrolysis of sodium chloride has been developed [U.S. Pat. No. 7,732,375]. This method utilizes the chloralkali process and it is described that energy consumption required for sodium hydroxide production can be reduced by recovering electricity from hydrogen produced as byproduct during the process. However, the process requires the fuel cell technology.

Also, a process of preparing calcium carbonate from waste cement by using sodium bicarbonate produced from electrolysis of sodium chloride as a quick precipitating agent has been developed [US Patent Publication No. 2010/0230293]. It is described that hydrogen produced at a cathode of an electrolytic cell is supplied to an anode containing a platinum electrode catalyst to produce hydrochloric acid and carbon dioxide is supplied to the cathode while maintaining pH at 14 or below to decrease the potential difference required for electrolysis and that the power necessary for sodium bicarbonate can be decreased theoretically. However, the pH difference at the cathode and the anode does not significantly affect the potential difference required to achieve a given current density and the decrease in power consumption is largely achieved through oxidation of hydrogen. In addition, when sodium bicarbonate is added directly to waste cement, it is not easy to elute alkali ions.

### SUMMARY

The inventors of the present invention have made efforts to solve the problems of the mineral carbonation technology of capturing carbon dioxide using minerals or waste resources containing alkali ions, i.e. excessive energy consumption and high cost. As a result, they have developed an improved process wherein a sodium chloride electrolysis system which generates an alkali ion eluting agent and a carbonate quick precipitating agent at the same time is introduced.

The present invention is directed to providing a method for preparing alkali metal carbonates, including processes of eluting an alkali ion from an inorganic material containing the alkali ion using hydrochloric acid (HCl) produced from electrolysis of sodium chloride and precipitating the eluted alkali ion as a carbonate using sodium hydroxide (NaOH) produced from the electrolysis.

The present invention is also directed to providing a system for preparing alkali metal carbonates, including an electrolysis system which produces hydrochloric acid and sodium hydroxide necessary for elution and precipitation of an alkali ion at the same time and a reaction system which prepares alkali metal carbonates from an inorganic material containing an alkali ion.

In an aspect, the present invention provides a method for preparing alkali metal carbonates, including: an electrolysis process of producing hydrochloric acid (HCl) at an anode cell and producing sodium hydroxide (NaOH) at a cathode cell by electrolyzing a sodium chloride (NaCl) aqueous solution; an elution process of selectively eluting an alkali ion from an inorganic material containing the alkali ion using the hydrochloric acid (HCl) produced at the anode cell; a sodium bicarbonate preparation process of converting the sodium hydroxide (NaOH) produced at the cathode cell to a sodium bicarbonate (NaHCO₃) quick precipitating agent by reacting with carbon dioxide (CO₂); and a carbonate preparation process of preparing a carbonate of an alkali ion by reacting the sodium bicarbonate (NaHCO₃) with the alkali ion obtained in the elution process.

In another aspect, the present invention provides a method for preparing alkali metal carbonates, including: an electrolysis process of producing hydrochloric acid (HCl) at an anode cell by electrolyzing a sodium chloride (NaCl) aqueous solution and producing a sodium bicarbonate (NaHCO₃) quick precipitating agent at a cathode cell by reacting sodium hydroxide with carbon dioxide supplied from outside; an elution process of selectively eluting an alkali ion from an inorganic material containing the alkali ion using the hydrochloric acid (HCl) produced at the anode cell; and a carbonate preparation process of preparing a carbonate of an alkali ion by reacting the sodium bicarbonate (NaHCO₃) produced at the cathode cell with the alkali ion obtained in the elution process.

In an exemplary embodiment of the present invention, the electrolysis process may be performed under the condition where the concentration of the sodium chloride aqueous solution is maintained at 0.1-35 wt %.

In another exemplary embodiment of the present invention, in the electrolysis process, a 0.1-35 wt % sodium chloride aqueous solution may be supplied to a central cell installed for the supply of sodium chloride and 0-20 wt % sodium chloride may be supplied to the cathode cell and the anode cell.

In another exemplary embodiment of the present invention, the electrolysis process may be performed at 10-120° C. under the condition where the potential difference between the cathode and the anode is maintained at 0.5-1.5 V.

In another exemplary embodiment of the present invention, in the electrolysis process, 0.1-2.0 M hydrochloric acid may be produced at the anode cell and 0.1-2.0 M sodium hydroxide may be produced at the cathode cell. In another exemplary embodiment of the present invention, the anode cell may be a gas diffusion electrode which generates a proton (H⁺) by oxidizing hydrogen (H₂).

In an exemplary embodiment of the present invention, the elution process may be performed under the molar ratio of the hydrochloric acid (HCl) to the molar ratio of the alkali ion contained in the inorganic material is maintained at 0.2-2.0:1.0.

In another exemplary embodiment of the present invention, the elution process may be performed under the condition where the solid-to-liquid ratio (kg/L) of the inorganic material con containing the alkali ion and the hydrochloric acid aqueous solution is maintained at 0.01-1.0.

In another exemplary embodiment of the present invention, the elution process may be performed at 10-120° C. for 5-120 minutes.

In another exemplary embodiment of the present invention, the inorganic material con containing the alkali ion supplied in the elution process may be an industrial waste or a mineral. For example, one or more selected from a group consisting of waste cement, slag, fly ash, feldspar (CaAl₂Si₂O₈), forsterite (Mg₂SiO₄), glauconite, ilmenite (FeTiO₃), listwanite (carbonated serpentinite), magnetite, olivine ((Mg,Fe)₂SiO₄), opoka, serpentine, serpentinite, talc (Mg₃Si₄Si₁₀(OH)₂) and wollastonite (CaSiO₃) may be used.

In an exemplary embodiment of the present invention, the carbonate preparation process may be performed at 10-120° C. for 5-120 minutes.

In another exemplary embodiment of the present invention, a filtrate discharged from the carbonate preparation process may be passed through a chelating ion-exchange resin membrane to obtain purified sodium chloride and the obtained sodium chloride may be recycled to the electrolysis process.

In another aspect, the present invention provides a reaction system for preparing alkali metal carbonates, including: an electrolysis reactor 10 which produces hydrochloric acid (HCl) and sodium hydroxide (NaOH) by electrolyzing sodium chloride (NaCl); an elution reactor 20 which selectively elutes an alkali ion from an inorganic material containing the alkali ion using the hydrochloric acid (HCl) supplied from the electrolysis reactor 10; a sodium bicarbonate preparation reactor 30 which produces sodium bicarbonate (NaHCO₃) by reacting the sodium hydroxide (NaOH) and the carbon dioxide (CO₂) supplied from the electrolysis reactor 10; and a carbonate preparation reactor 40 which produces a carbonate of an alkali ion by reacting the alkali ion supplied from the elution reactor 20 with the sodium bicarbonate supplied from the sodium bicarbonate preparation reactor 30.

In another aspect, the present invention provides a reaction system for preparing alkali metal carbonates, including: an electrolysis reactor 10 which produces hydrochloric acid (HCl) and sodium hydroxide (NaOH) by electrolyzing sodium chloride (NaCl); an elution reactor 20 which selectively elutes an alkali ion from an inorganic material comprising the alkali ion using the hydrochloric acid (HCl) supplied from the electrolysis reactor 10; and a carbonate preparation reactor 40 which converts the sodium hydroxide (NaOH) supplied from the electrolysis reactor 10 to sodium bicarbonate (NaHCO₃) by reacting with carbon dioxide (CO₂) and produces a carbonate of an alkali ion by reacting the sodium bicarbonate (NaHCO₃) with the alkali ion supplied from the elution reactor 20.

In an exemplary embodiment of the present invention, the reaction system for preparing alkali metal carbonates according to the present invention may further include a sodium chloride purifier 50 which separates and purifies sodium chloride from a filtrate discharged from the carbonate preparation reactor 40.

In another exemplary embodiment of the present invention, the electrolysis reactor 10 according to the present invention may include an anode cell, a central cell for supplying a sodium chloride aqueous solution and a cathode cell in sequence, have an anion exchange membrane equipped between the anode cell and the central cell so that chloride anion can migrate therethrough and have a cation exchange membrane equipped between the cathode cell and the central cell so that sodium cation can migrate therethrough. Sodium hydroxide may be generated at the cathode cell and hydrochloric acid may be generated at the anode cell.

According to the preparation method of the present invention, an alkali ion eluting agent and a quick precipitating agent which converts an eluted alkali ion to a carbonate can be produced at the same time using an inexpensive electrolysis system and, as a result, the problems of the mineral carbonation technology of excessive energy consumption and high cost can be solved.

Also, according to the preparation method of the present invention, valuable carbonates such as calcium carbonate or magnesium carbonate can be prepared effectively from minerals or industrial wastes. In particular, expensive precipitated calcium carbonate can be prepared.

In addition, the preparation method of the present invention is advantageous in that the inorganic material discharged after elution of the alkali ion can be used as a construction material and the overall process is environment-friendly since, for example, the filtrate discharged after filtration of the prepared precipitated carbonate can be recycled to the electrolysis reactor after purification of sodium chloride.

### BRIEF DESCRIPTION OF THE DRAWINGS

FIG. 1 describes a process for preparing alkali metal carbonates according to an exemplary embodiment of the present invention.

FIG. 2 schematically shows an electrolysis system introduced in the present invention.

FIG. 3 shows current measured under constant voltage and pH change of each cell.

FIG. 4 shows current and pH change when (A) 0 wt %, (B) 5 wt %, (C) 10 wt % or (D) 20 wt % sodium chloride solution is supplied.

FIG. 5 shows current and pH change when sodium chloride solution is supplied at a flow rate of (A) 0.5 mL/min, (B) 1.0 mL/min, (C) 2.0 mL/min or (D) 4.0 mL/min.

FIG. 6 shows calcium ion elution rate depending on hydrochloric acid concentration and elution temperature. (A) shows elution rate of calcium ion in slag depending on the concentration of a hydrochloric acid aqueous solution, (B) shows elution rate of calcium ion in waste cement depending on the concentration of a hydrochloric acid aqueous solution, (C) shows elution rate of calcium ion in slag depending on elution temperature and (D) shows elution rate of calcium ion in waste cement depending on elution temperature.

FIG. 7 shows XRD patterns of calcium carbonate prepared at 30° C., 50° C. and 70° C. using slag.

FIG. 8 shows XRD patterns of calcium carbonate prepared at 10° C., 30° C., 50° C. and 70° C. using waste cement.

FIG. 9 shows scanning electron microscopic (SEM) images of calcium carbonate prepared at 10° C., 30° C., 50° C. and 70° C. using waste cement.

<Detailed Description of Main Elements>

10: electrolysis reactor

| | |
|---|---|
| 11: central cell | 12: anode cell |

13: cathode cell
14, 15: hydrochloric acid aqueous solution supply line
16: sodium hydroxide supply line
20: alkali ion elution reactor
21: inorganic material supply line
22: post-elution inorganic material discharge line
30: carbonate preparation reactor

| | |
|---|---|
| 31: alkali ion supply line | 32: carbonate discharge port |

33: carbonate filtrate discharge port
40: sodium bicarbonate preparation reactor

| | |
|---|---|
| 41: carbon dioxide supply line | 42: sodium bicarbonate supply line |

50: sodium chloride purifier
51: sodium chloride aqueous solution recycle line
52: sodium chloride aqueous solution supply line
53: waste solution discharge port

### DETAILED DESCRIPTION

The present invention relates to a method for preparing a carbonate of an alkali ion by eluting an alkali ion from an inorganic material containing the alkali ion and converting the eluted alkali ion to a carbonate and a reaction system used for the method. When the alkali ion is eluted and converted to a carbonate, an eluting agent and a quick precipitating agent produced and supplied at the same time using an electrolysis system.

In the present invention, the term ‘alkali ion’ collectively refers to an alkali metal ion and an alkaline earth metal ion. Unless specified otherwise, the term alkali ion used in the present invention refers to an alkali metal ion or an alkaline earth metal ion.

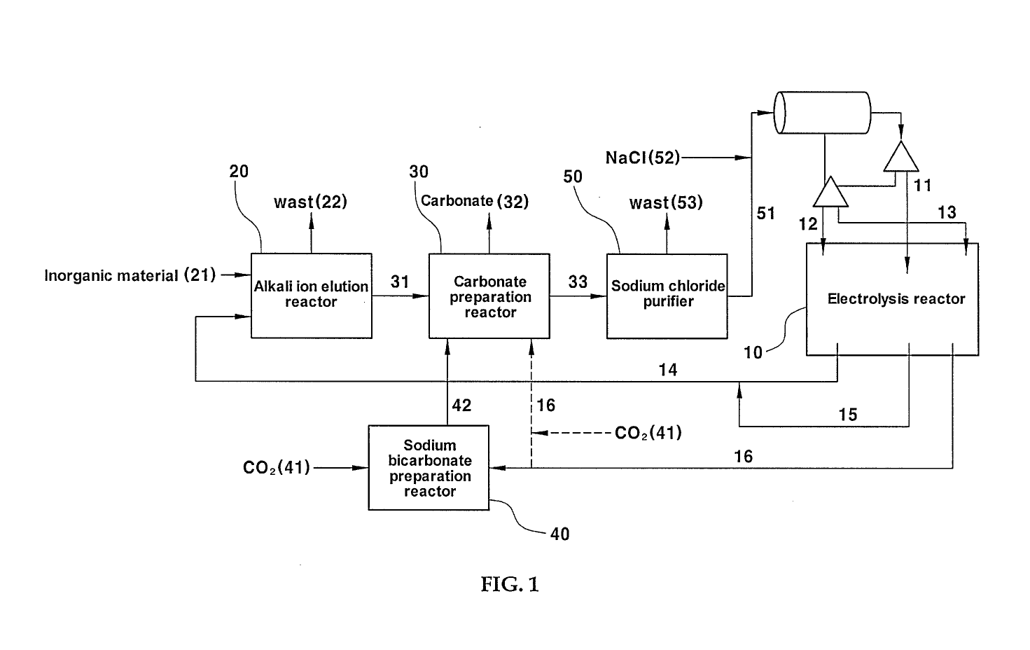

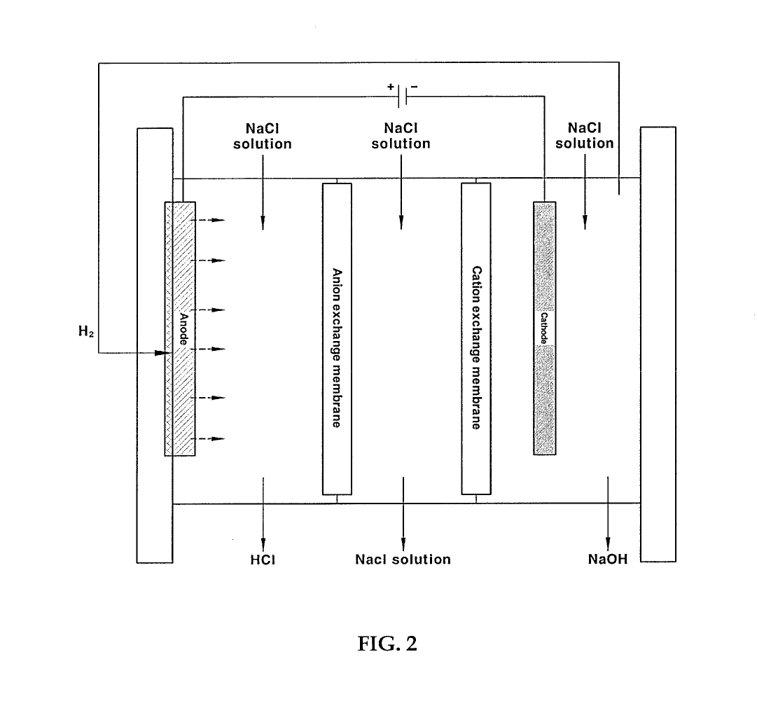

The method for preparing a carbonate of an alkali ion according to the present invention will be described in detail referring to a process diagram shown in FIG. 1 and a schematic diagram shown in FIG. 2.

FIG. 1 describes a process for preparing an inorganic carbonate from an inorganic material containing an alkali ion according to an exemplary embodiment of the present invention, and FIG. 2 schematically shows an electrolysis system introduced in the preparation method of the present invention. The method for preparing an inorganic carbonate according to the present invention or the reaction system used in the preparation method is not limited by the process diagram of FIG. 1 or the schematic diagram of FIG. 2 by any means.

The method for preparing a carbonate of an alkali ion of the present invention may include four processes of: i) a sodium chloride electrolysis process; ii) an elution process of eluting an alkali ion from an inorganic material using hydrochloric acid (HCl) produced in the electrolysis process; iii) a process of preparing sodium bicarbonate (NaHCO₃) by reacting sodium hydroxide (NaOH) produced in the electrolysis process with carbon dioxide; and iv) a carbonate preparation process of converting the sodium bicarbonate (NaHCO₃) to a carbonate of the alkali ion obtained in the elution process using a quick precipitating agent.

The method for preparing a carbonate of an alkali ion of the present invention may be simplified by preparing sodium bicarbonate (NaHCO₃) by reacting the sodium hydroxide produced in the electrolysis process i) with carbon dioxide by adding the carbon dioxide to a cathode cell and using the same in the carbonate preparation process iv). That is to say, the method for preparing a carbonate of an alkali ion of the present invention may include three processes of: i-1) an electrolysis process of producing hydrochloric acid (HCl) at an anode cell by electrolyzing a sodium chloride (NaCl) aqueous solution and producing a sodium bicarbonate (NaHCO₃) quick precipitating agent at a cathode cell by reacting sodium hydroxide with carbon dioxide supplied from outside; ii) an elution process of selectively eluting an alkali ion from an inorganic material comprising the alkali ion using the hydrochloric acid (HCl) produced at the anode cell; and iv-1) a carbonate preparation process of preparing a carbonate of an alkali ion by reacting the sodium bicarbonate (NaHCO₃) produced at the cathode cell with the alkali ion obtained in the elution process.

Each process of the method for preparing a carbonate of an alkali ion according to the present invention will be described in further detail.

The sodium chloride electrolysis process i) is performed by the electrolysis system shown in FIG. 2. As seen from FIG. 2, the electrolysis reactor 10 includes a cation exchange membrane, an anion exchange membrane and three cells (an anode cell, a cathode cell and a central cell). Specifically, the electrolysis reactor 10 includes the central cell for supplying a sodium chloride aqueous solution, has the anion exchange membrane equipped between the anode cell and the central cell so that chloride anion can migrate therethrough and has the cation exchange membrane equipped between the cathode cell and the central cell so that sodium cation can migrate therethrough. The anode cell and the central cell may also be integrated as a single cell.

Sodium hydroxide (NaOH) and hydrogen (H₂) are produced at the cathode cell from a hydroxide ion (OH⁻) generated from electrolysis of water and sodium ion (Na⁺) that has migrated through the cation exchange membrane. At the anode cell, which is a gas diffusion anode, the hydrogen (H₂) supplied from the cathode is oxidized to a proton (H⁺) and hydrochloric acid (HCl) is produced from reaction with a chloride anion (Cl⁻) that has migrated through the anion exchange membrane. To summarize, when a sodium chloride aqueous solution is supplied to the electrolysis reactor 10, hydrochloric acid (HCl) is produced at the anode cell and sodium hydroxide (NaOH) is produced at the cathode cell.

A 0.1-35 wt % sodium chloride aqueous solution is supplied to the electrolysis reactor 10. Specifically, the sodium chloride aqueous solution supplied through the central cell may have a concentration of 0.1-35 wt %, specifically 10-35 wt %, more specifically 20-35 wt %. A sodium chloride aqueous solution of higher concentration relative to the anode cell and the cathode cell is supplied. The concentration of the sodium chloride aqueous solution supplied through the anode cell and the cathode cell is respectively 0-20 wt %, specifically 0-10 wt %, which is lower relative to the sodium chloride aqueous solution supplied through the central cell. It is recommended that the concentration of the sodium chloride aqueous solution supplied to the central cell is higher relative to the sodium chloride aqueous solutions supplied to the anode and cathode cells in order to improve migration rate of the chloride anion and the sodium ion to the anode and the cathode, respectively, and to allow recycling of the hydrochloric acid and the sodium hydroxide produced at the anode and cathode cells.

The electrolysis reactor 10 may be operated at 10-120° C., specifically at 20-90° C., more specifically at 30-60° C.

A gas diffusion electrode is used as the anode cell of the electrolysis reactor. The gas diffusion electrode includes a current collector and a gas diffusion layer, so that hydrogen can diffuse well and oxidation of hydrogen is performed effectively at the electrode. Hydrogen is supplied together with water vapor to ensure contact with the electrode and diffusion of the produced proton. The gas diffusion electrode may use platinum as a main electrode catalyst. A platinum compound as it is or as supported on a conductive support with high specific surface area. The support with high specific surface area may be carbon paper, glassy carbon, titanium mesh, nickel mesh, etc. Platinum may be supported by dispersing platinum nanoparticles in a conductive polymer solution, by supporting platinum on porous conductive nanoparticles or by using an ion beam. Also, platinum nanoparticles may be supported on a conductive support using an electrochemical method. The present invention is not particularly limited in the catalyst supporting method. Also, a bimetal of platinum and a metal selected from rhodium, palladium, iridium, nickel, etc. may be used. In addition, a bimetal containing gold, silver, copper, tin, indium, etc. may be used. A diffusion layer and a current collecting layer are necessary to fix the gas diffusion electrode and effectively collect current. The materials of the diffusion layer and the current collector may be selected from carbon paper, titanium mesh, nickel mesh, etc.

As the cathode cell of the electrolysis reactor, a gas diffusion electrode or a plate electrode immersed in a solution may be used. Platinum may be used as a main electrode catalyst of the cathode. For supporting of the catalyst, nickel, titanium or glassy carbon may be used. Use of a porous nickel support is recommended in terms of economy. The method for supporting platinum on nickel is the same as that described for the anode. The hydrogen (H₂) produced at the cathode cell is supplied to the gas diffusion electrode of the anode and then converted to a proton (H⁺).

Electrolysis is performed while maintaining the potential difference between the cathode and the anode at 0.5-1.5 V, specifically 1.5 V. If the potential difference between the two electrodes is maintained at 0.5 V or less, electrolysis may not occur. And, if the potential difference exceeds 1.5 V, chlorine gas may be generated as chloride anion is oxidized instead of hydrogen.

As a result of electrolysis under the above condition, 0.1-2.0 M hydrochloric acid (HCl) is produced at the anode cell, 0.1-1.0 M hydrochloric acid is produced at the central cell and 0.1-2.0 M sodium hydroxide (NaOH) is produced at the cathode cell. The hydrochloric acid (HCl) produced from the electrolysis is used as an eluting agent for eluting an alkali ion from an inorganic material containing the alkali ion and the sodium hydroxide (NaOH) is used as a quick precipitating agent for quickly precipitating the alkali ion. That is to say, the hydrochloric acid (HCl) is supplied to an alkali ion elution reactor 20 and the sodium hydroxide (NaOH) is supplied to a carbonate preparation reactor 30 or to the sodium bicarbonate preparation reactor 40 to be used as a quick precipitating agent.

Also, while the electrolysis is performed, carbon dioxide may be supplied to the cathode cell and a sodium bicarbonate (NaHCO₃) quick precipitating agent prepared from the reaction of the carbon dioxide with the sodium hydroxide produced at the cathode cell may be supplied to the carbonate preparation reactor 30.

In the alkali ion elution process ii), an alkali ion is eluted from an inorganic material using the hydrochloric acid (HCl) produced in the electrolysis process as an eluting agent.

The elution reactor 20 includes a an alkali ion-containing inorganic material supply line 21 and a hydrochloric acid (HCl) aqueous solution supply line 14. The elution reactor 20 is also connected to an alkali ion supply line 21 which supplies the eluted alkali ion to the carbonate preparation reactor 30 and an inorganic material discharge line 22 which discharges the alkali ion-eluted inorganic material. The inorganic material discharged from the inorganic material discharge line 22 may be recycled as an industrial resource such as a construction material.

The alkali ion-containing inorganic material supplied in the elution process may be any inorganic material containing an alkali metal ion belonging to the group 1A in the periodic table or an alkaline earth metal ion belonging to the group 2A, including industrial wastes, minerals, etc. For example, the alkali ion-containing inorganic material may be one or more selected from a group consisting of waste cement, slag, fly ash, feldspar (CaAl₂Si₂O₈), forsterite (Mg₂SiO₄), glauconite, ilmenite (FeTiO₃), listwanite (carbonated serpentinite), magnetite, olivine ((Mg,Fe)₂SiO₄), opoka, serpentine, serpentinite, talc (Mg₃Si₄Si₁₀(OH)₂) and wollastonite (CaSiO₃).

The concentration of the inorganic material supplied to the elution reactor is 0.01-1.0 kg/L, specifically 0.05-0.3 kg/L.

And, the concentration of the hydrochloric acid (HCl) supplied to the elution reactor may be specifically 0.1-2.0 M. In particular, if the inorganic material is fly ash or waste concrete, 0.25-2.0 M hydrochloric acid (HCl) is suitable to elute the alkali ion. If the hydrochloric acid concentration is lower than 0.1 M, the elution rate of the alkali ion from the inorganic material may be low. And, if it exceeds 2.0 M, it is difficult to selectively elute the alkali ion because the inorganic material is dissolved almost completely.

The supply amount of the inorganic material and the hydrochloric acid supplied to the elution reactor is determined by the molar ratio of the alkali ion contained in the inorganic material and the hydrochloric acid. The molar ratio of the alkali ion contained in the inorganic material to the hydrochloric acid (HCl) is maintained at 0.2-2.0:1.0. If the molar ratio of the alkali ion contained in the inorganic material to the hydrochloric acid (HCl) is smaller than 0.2:1.0, i.e., if the hydrochloric acid is used in relatively excess amount, the purity of the prepared carbonate of an alkali ion may decrease because other metal ions may also be eluted in addition to the alkali ion. On the other hand, if the molar ratio of the alkali ion contained in the inorganic material to the hydrochloric acid (HCl) exceeds 2.0:1.0, i.e., if the hydrochloric acid is used in relatively small amount, elution may not be performed effectively and a large quantity of alkali ions may be contained in the inorganic material discharged through the inorganic material discharge line 22.

As described above, to determine the supply amount of the inorganic material and the hydrochloric acid, the content of the alkali ion contained in the inorganic material and the concentration of the hydrochloric acid aqueous solution should be calculated accurately. In the present invention, considering that the average content of the alkali ion contained in the inorganic material and the concentration of the hydrochloric acid aqueous solution can be adjusted in a range of 0.1-1 M, the supply amount of the alkali ion-containing inorganic material and the hydrochloric acid aqueous solution supplied to the elution process is controlled to a solid-to-liquid ratio (kg/L) of 0.01-1.0. Within this solid-to-liquid ratio range, the alkali ion can be eluted economically from the inorganic material.

The elution reactor 20 may be operated at 10-120° C., specifically at 30-90° C., more specifically at 30-70° C. The elution reaction is performed for 10-60 minutes, specifically for 20-40 minutes, to obtain an alkali ion-containing solution. If the elution reaction time is shorter than 10 minutes, the alkali ion elution rate may be low because of insufficient contact time between the inorganic material and the hydrochloric acid aqueous solution. And, if the elution reaction time exceeds 60 minutes, a calcium carbonate of low purity is prepared because the elution rate of other metal ions such as iron, silicon, etc. increases.

In the carbonate preparation process iv), the alkali ion is converted to a carbonate using the sodium bicarbonate (NaHCO₃) wherein carbon dioxide is fixed as a quick precipitating agent.

In the present invention, the sodium bicarbonate (NaHCO₃) is used to precipitate the alkali ion as a carbonate. The sodium bicarbonate is prepared by reacting the sodium hydroxide (NaOH) produced at the cathode cell of the electrolysis reactor 10 with carbon dioxide (CO₂). In the present invention, sodium bicarbonate prepared by reacting sodium hydroxide with carbon dioxide in a sodium bicarbonate preparation reactor 40 may be supplied to the carbonate preparation reactor 30. Alternatively, sodium bicarbonate may be prepared by supplying carbon dioxide and sodium hydroxide to the carbonate preparation reactor 30. Alternatively, sodium hydroxide produced at the cathode cell by supplying carbon dioxide to the cathode cell of the electrolysis reactor may be used to prepare sodium bicarbonate.

The concentration of the sodium bicarbonate used as the alkali ion quick precipitating agent may be maintained at 0.1-1.0 M, specifically 0.5-1.0 M. If the concentration of the sodium bicarbonate is lower than 0.1 M, the precipitation yield of a carbonate is very low. And, if the concentration of the sodium bicarbonate exceeds 1.0 M, process control is difficult because the sodium bicarbonate is not dissolved well.

The carbonate preparation reactor 30 may be operated at 10-120° C., specifically at 10-70° C. If the temperature of the carbonate preparation reactor is 10-70° C., cubic and spherical or amorphous calcium carbonate may be obtained with high purity of 90-99%. In contrast, if the temperature of the carbonate preparation reactor is below 10° C., cubic calcium carbonate is mainly prepared and, if the temperature exceeds 70° C., conical calcium carbonate is prepared. The carbonate preparation reaction is performed for 5-120 minutes, specifically for 20-90 minutes, to prepare a carbonate of an alkali ion.

As described above, the sodium bicarbonate (NaHCO₃) used as the quick precipitating agent may be prepared in a separate reactor and then supplied to the carbonate preparation reactor 30. Accordingly, the reaction system of the present invention may further include a sodium bicarbonate preparation reactor 40. In the sodium bicarbonate preparation reactor 40, sodium bicarbonate is prepared by reacting carbon dioxide (CO₂) with the sodium hydroxide (NaOH) supplied from the electrolysis reactor 10.

In addition, the reaction system of the present invention may further include a sodium chloride purifier 50. The sodium chloride purifier 50 is equipped with a chelating ion-exchange resin membrane and removes inorganic alkali ions other than sodium ion from a solution discharged from the carbonate preparation reactor 30. After passing through the sodium chloride purifier 50, the concentration of calcium and magnesium ions can be reduced to 20 ppb and the concentration of iron ion can be reduced to 1 ppm.

If necessary, the purified sodium chloride solution discharged from the sodium chloride purifier 50 may be concentrated using a reverse osmosis membrane and sodium chloride corresponding to the lost amount may be supplemented and recycled to the electrolysis reactor 10.

Hereinafter, the present invention is described more specifically referring to the following examples. The following examples are provided for illustrative purposes only and the present invention is not limited thereby. Although slag or waste cement is used as an alkali ion-containing inorganic material in the examples, the effect desired by the present invention can also be achieved sufficiently by using an alkali ion-containing mineral.

### Examples

### Example 1

An electrolysis reactor was configured as follows. A 55×75×85 (mm) electrode cell as shown in FIG. 2 was configured using Teflon. A 23×23 (mm) Pt/C diffusion electrode as an anode cell was connected to a central cell with an anion exchange membrane interposed therebetween. A 20×30 (mm) nickel electrode as a cathode cell was connected to the central cell with a cation exchange membrane interposed therebetween. Each cell was equipped with an injection port and a discharge port to allow entrance and exit of a solution. It was configured such that migration of the solution between the cells is impossible.

Hydrochloric acid and sodium hydroxide were prepared by supplying a 20 wt % sodium chloride aqueous solution to the central cell of the electrolysis reactor and supplying a 5 wt % sodium chloride aqueous solution to the anode cell and the cathode cell. Each solution was supplied to each cell at a rate of 0.5 mL/min. Hydrogen prepared at the cathode was supplied to the gas diffusion anode. Reaction temperature was room temperature and the hydrogen produced at the cathode was supplied to the gas diffusion anode while maintaining the potential difference between the cathode and the anode at 1.5 V. 0.9 M hydrochloric acid was prepared at the anode. At the cathode, 1.0 M sodium hydroxide was prepared, which was converted to sodium bicarbonate by supplying carbon dioxide. A sodium chloride supply solution contained 0.1 M hydrochloric acid when being discharged and 0.5 M hydrochloric acid was prepared when the sodium chloride supply solution and the anode solution were combined.

An alkali ion was eluted from waste concrete in an alkali ion elution reactor using the 0.5 M hydrochloric acid solution. The solid-to-liquid ratio of the waste concrete and the 0.5 M hydrochloric acid solution was set to be 0.06 kg/L. An elution solution discharged from the elution reactor contained 54.44 g/L calcium chloride, 1.9 g/L magnesium chloride and 0.25 g/L ferric chloride. No silicon ion was detected.

A carbonate was prepared in a carbonate preparation reactor by supplying the elution solution and the 1.0 M sodium bicarbonate aqueous solution. High-purity calcium carbonate of 98.9% or higher purity was prepared.

### Example 2

A carbonate was prepared in the same manner as described in Example 1, except that electrolysis was performed under the following condition.

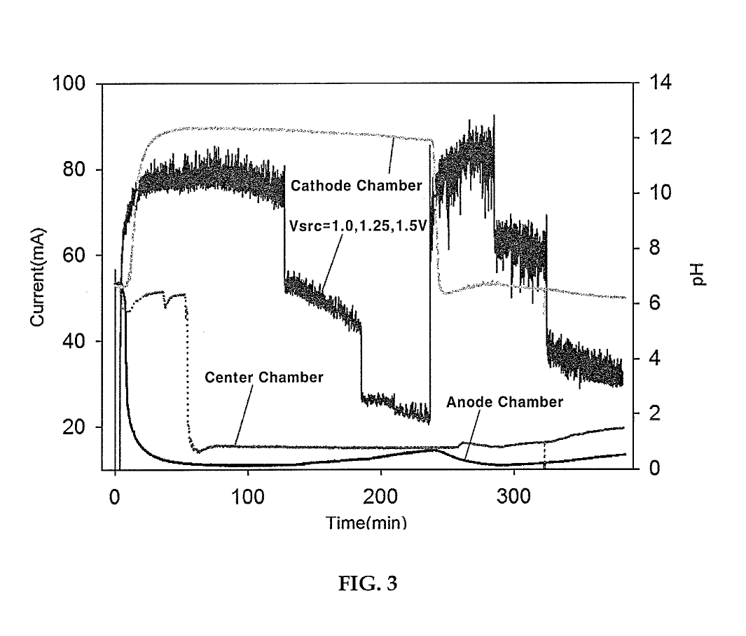

A 20 wt % sodium chloride solution was prepared as a central cell supply solution and a 5 wt % sodium chloride solution was prepared as a cathode and anode cell supply solution. Each supply solution was supplied to each cell at a rate of 0.5 mL/min. Hydrogen prepared at the cathode was supplied to the gas diffusion anode. Current was measured while applying a constant voltage of 1.5 V, 1.25 V and 1.0 V in sequence to the electrode and carbon dioxide was supplied after the cells were stabilized. This procedure was repeated. The pH of a solution discharged from each cell was measured using a pH meter. The result is shown in FIG. 3. At a constant voltage of 1.5 V, the maximum current was measured to be 91.7 mA and the current decreased as the constant voltage decreases.

The pH of the cathode was decreased from about 12 before the supply of carbon dioxide to 6 after the carbon dioxide supply. This confirms that hydrochloric acid was produced at the anode, sodium hydroxide was produced at the cathode and the reaction NaOH+CO₂→NaHCO₃ proceeded after the supply of carbon dioxide. The concentration of the hydrochloric acid and the sodium hydroxide produced at each cell before the supply of carbon dioxide was measured. It was found out that ˜1.0 M hydrochloric acid was produced at the anode cell and the central cell and ˜0.75 M sodium hydroxide was produced at the cathode cell.

### Example 3

A carbonate was prepared in the same manner as described in Example 1, except that electrolysis was performed under the following condition.

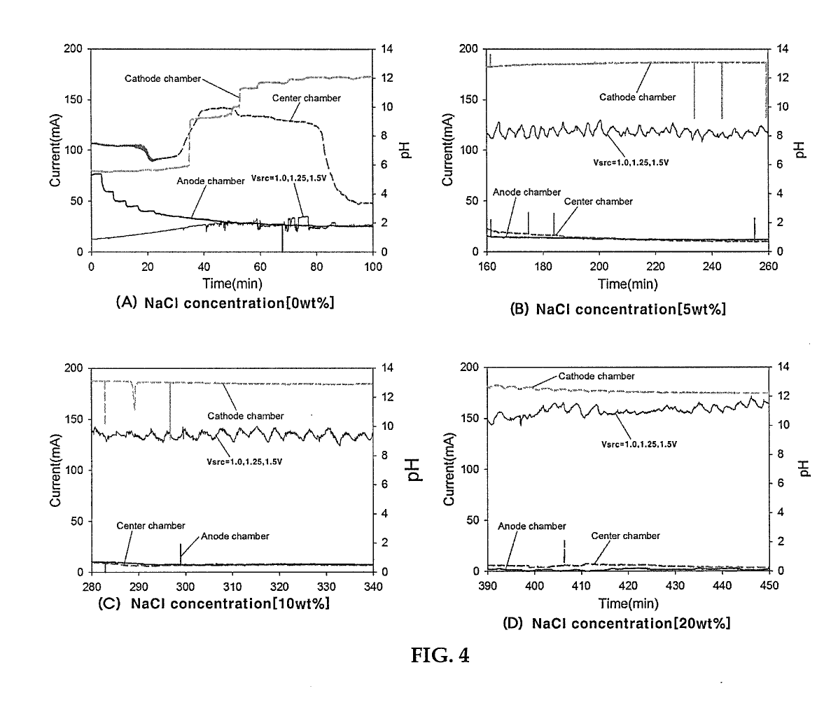

A 20 wt % sodium chloride solution was prepared as a central cell supply solution and 0, 5, 10, 20 wt % sodium chloride solutions were prepared as cathode and anode cell supply solutions. Each supply solution was supplied to each cell at a rate of 0.5 mL/min. Hydrogen prepared at the cathode was supplied to the gas diffusion anode. Current was measured while applying a constant voltage of 1.5 V to the electrode. The pH of a solution discharged from each cell was measured using a pH meter. The measured current and solution pH depending on the concentration of sodium chloride supplied to the cathode and the anode are shown in FIG. 4.

As seen from FIG. 4, when a 0 wt % sodium chloride solution or distilled water was supplied, the maximum current was measured to be 39.04 mA. When a 5 wt % sodium chloride solution was supplied as in Example 2, the current was 120.12 mA. When the sodium chloride concentration was increased to 10 wt % and 20 wt %, the current was measured to be 134.23 mA and 164.83 mA, respectively. Therefore, it was confirmed that the current increases with the concentration of the sodium chloride solution supplied to the anode and the cathode.

### Example 4

A carbonate was prepared in the same manner as described in Example 1, except that electrolysis was performed under the following condition.

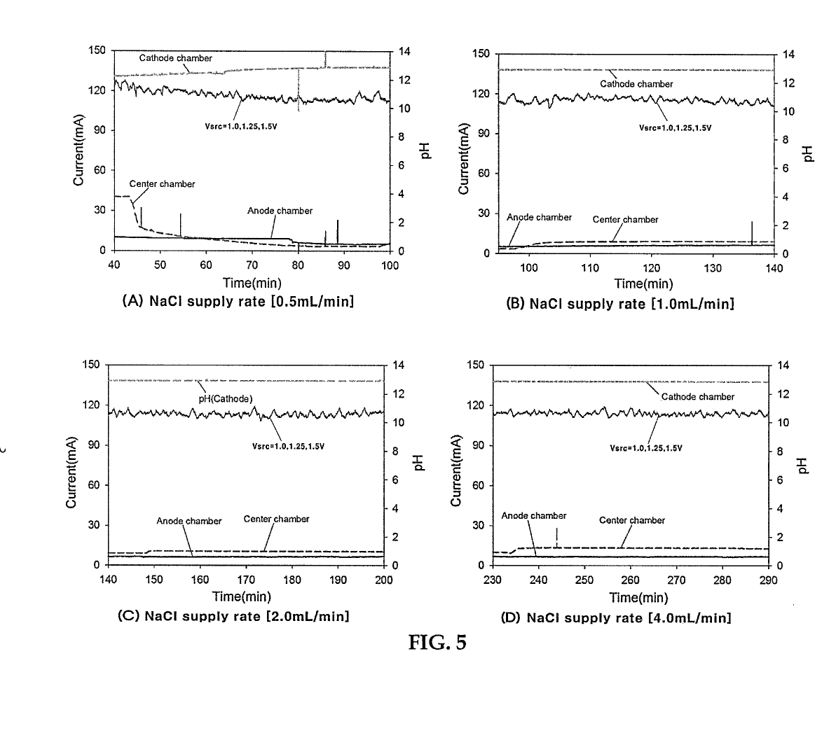

A 20 wt % sodium chloride solution was prepared as a central cell supply solution and a 5 wt % sodium chloride solution was prepared as a cathode and anode cell supply solution. Each supply solution was supplied to each cell at a rate of 0.5, 1.0, 2.0 and 4.0 mL/min. Hydrogen prepared at the cathode was supplied to the gas diffusion anode. Current was measured while applying a constant voltage of 1.5 V to the electrode. The pH of a solution discharged from each cell was measured using a pH meter. The result is shown in FIG. 5.

As seen from FIG. 5, the current was measured to be 116 mA without regard to the flow rate of the supply solution. The pH of the central cell increased after stabilization.

### Example 5

A carbonate was prepared in the same manner as described in Example 1, except that an alkali ion was eluted from an inorganic material under the following condition.

Slag powder and waste concrete powder were used as inorganic materials. Steelmaking slag was pulverized to a size of 30 μm or smaller and waste concrete was pulverized to a particle size of 75 μm or smaller. The calcium and magnesium contents of the slag powder and the waste concrete powder used in this example are shown in Table 1.

TABLE 1

| | Ca (wt %) | Mg (wt %) |
|---|---|---|
| Steelmaking slag | 29.00 | 2.76 |
| Waste cement | 20.65 | 0.91 |

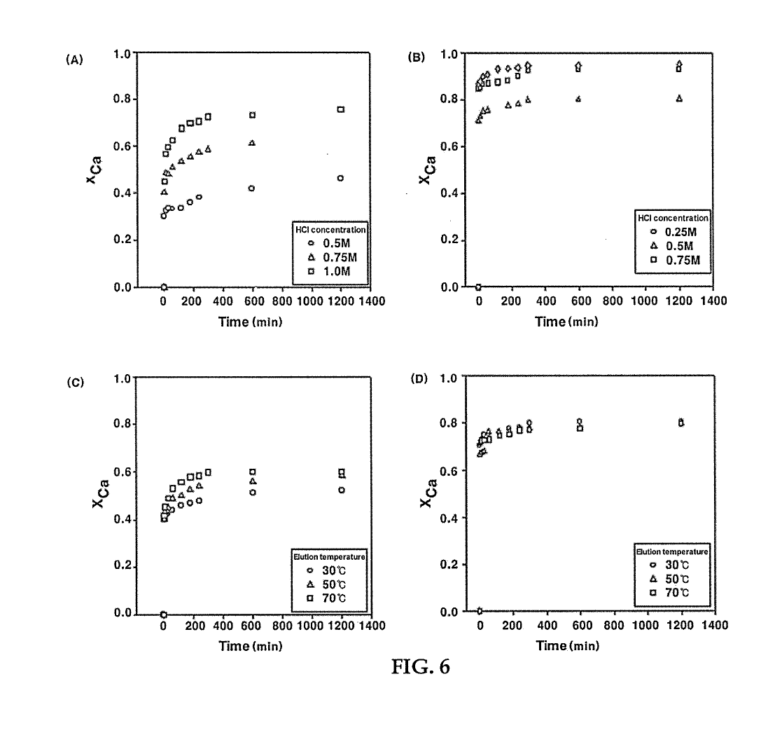

0.25, 0.5, 0.75 and 1 M hydrochloric acid aqueous solutions were prepared to elute the calcium ion. Reaction was performed at room temperature for 20 minutes with the solid-to-liquid ratio (kg/L) of the prepared hydrochloric acid aqueous solution and the steelmaking slag or waste concrete being 0.03. During the reaction, an elution solution was taken using a syringe filter and the concentration of calcium ion was measured by ion-exchange chromatography. The elution rate of calcium ion was calculated according to Equation 1. The elution rate of calcium ion depending on the hydrochloric acid concentration and the elution temperature is shown in FIG. 6.

Elution rate=Calcium content in solution/Calcium content in raw material [Equation 1]

As seen from FIG. 6, the elution rate was 98% or higher.

### Example 6

A carbonate was prepared in the same manner as described in Example 1, except that carbonate preparation was performed under the following condition.

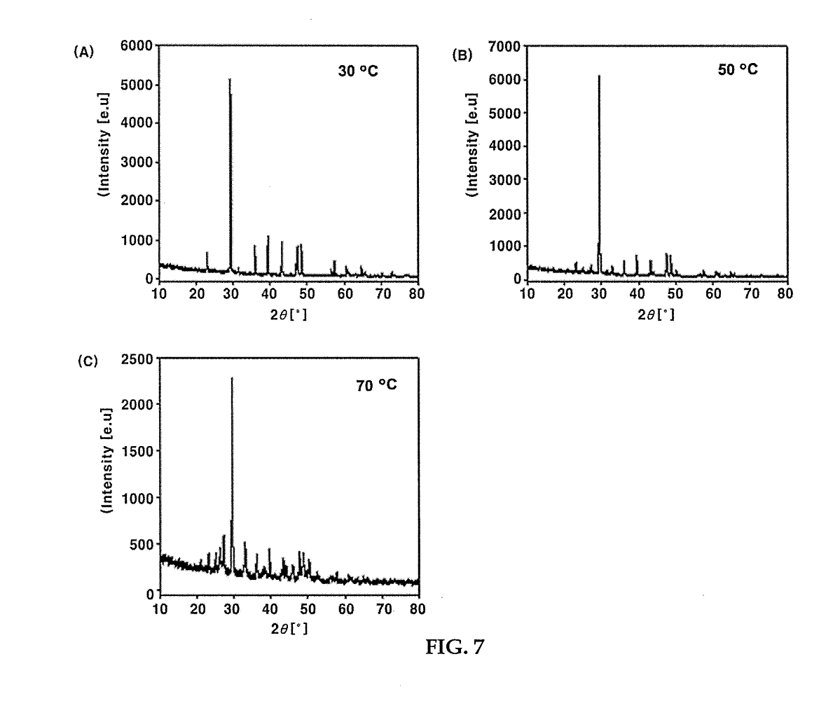

A 1 M sodium bicarbonate aqueous solution and a 0.5 M hydrochloric acid aqueous solution were prepared. A calcium ion-eluted solution was prepared by performing reaction at 70° C. for 20 minutes with the solid-to-liquid ratio (kg/L) of fine steelmaking slag powder and the prepared hydrochloric acid solution being 0.03. Calcium carbonate was prepared by reacting the sodium bicarbonate aqueous solution with the elution solution at 30° C., 50° C. and 70° C. for 60 minutes and then dried at 110° C. for 3 hours. The calcium carbonates produced at different reaction temperatures was analyzed by XRD. The result is shown in FIG. 7.

As seen from FIG. 7, a calcite peak was observed in the calcium carbonate prepared at 30° C. The calcium carbonate prepared at 50° C. showed a strong calcite peak and a weak vaterite peak. The calcium carbonate prepared at 70° C. showed all of calcite, aragonite and vaterite peaks.

### Example 7

A carbonate was prepared in the same manner as described in Example 1, except that carbonate preparation was performed under the following condition.

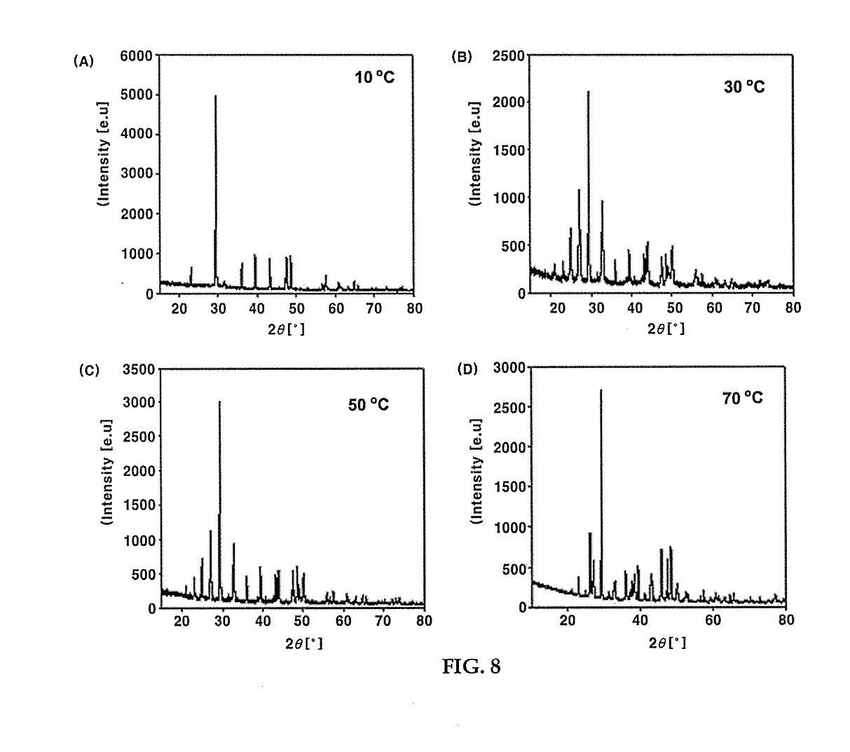

A 1 M sodium bicarbonate aqueous solution was prepared. A calcium ion-eluted solution was prepared by performing reaction at 70° C. for 20 minutes with the solid-to-liquid ratio (kg/L) of fine waste concrete powder and a 0.25 M hydrochloric acid solution being 0.03. Calcium carbonate was prepared by reacting the sodium bicarbonate aqueous solution with the elution solution at 10° C., 30° C., 50° C. and 70° C. for 1 hour and then dried at 110° C. for 3 hours. The crystal structure of the calcium carbonates produced at different reaction temperatures was analyzed by XRD. The result is shown in FIG. 8.

As seen from FIG. 8, only a calcite peak was observed for the calcium carbonate prepared at 10° C. The calcium carbonates prepared at 30° C. and 50° C. showed calcite and vaterite peaks. The calcium carbonates prepared at 70° C. was identified as conical calcium carbonate because an aragonite peak was detected.

### Example 8

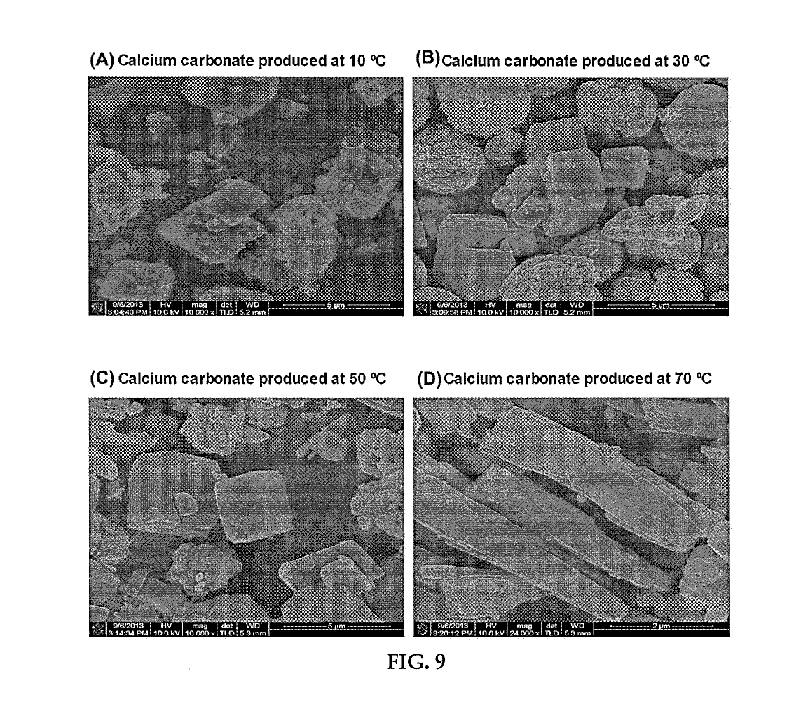

The crystal structure of the calcium carbonates produced in Example 7 was analyzed using a scanning electron microscope. The result is shown in FIG. 9.

As seen from the scanning electron microscopic images in FIG. 9, the calcium carbonates prepared at 10° C. was identified as cubic calcium carbonate. At 30° C. and 50° C., spherical or amorphous calcium carbonate and cubic calcium carbonate were produced at the same time. At 70° C., conical calcium carbonate was produced.

### Example 9

XRF analysis was performed to investigate the purity of the calcium carbonates prepared in Example 6. The result is shown in Table 2. All the metal constituents except for calcium were represented as oxide form.

TABLE 2

| | Composition (wt %) | | |
|---|---|---|---|
| Constituents | 30° C. | 50° C. | 70° C. |
| Na₂O | 0.734 | 0.574 | 0.669 |
| MgO | 0.761 | 0.551 | 0.371 |
| Al₂O₃ | 0.0848 | — | — |
| SiO₂ | 1.1 | 0.0717 | 0.0252 |
| P₂O₅ | 0.0287 | 0.0374 | 0.0368 |
| SO₃ | 0.0418 | 0.0596 | 0.043 |
| K₂O | — | — | 0.0014 |
| MnO | 0.0498 | 0.0571 | 0.0371 |
| Fe₂O₃ | — | — | 0.0034 |
| NiO | — | — | — |
| CuO | 0.0035 | 0.0026 | — |
| ZnO | 0.0045 | 0.0078 | — |
| SrO | 0.0473 | 0.0576 | 0.0495 |
| CaCO₃ | 97.1 | 98.6 | 98.7 |
| Total | 100 | 100 | 100 |

As seen from Table 2, the purity of calcium carbonate increased with the reaction temperature and the highest purity was 98.7%. Considering that Na can be sufficiently dissolved in pure water, the purity can be further improved by increasing the calcium carbonate washing time.

The present invention can be summarized as follows.

The electrolysis reactor used in the present invention includes three electrode cells and anion and cation exchange membranes. The gas diffusion anode structure showed the highest current density. When a platinum electrode dispersed on carbon paper was used, the current density was 50 mA/cm² or higher at 25° C. and a potential difference of 1.5 V even with a small loading amount of 0.5 mg/cm² or less. A similar result was obtained when an electrode in which platinum nanoparticles were electrochemically supported on carbon paper was used. In particular, it is to be noted that the hydrogen oxidation electrode system had the largest effect on the current density for preparation of acids and alkalis and a potential difference of 50 mA/cm² or higher could be achieved at a potential difference of 1.5 V when the diffusion anode structure was used.

Since the reaction rate is faster at the cathode than the anode, the overall reaction rate is controlled by the anode. By controlling the cathode pH at 12.0-14.0 and the anode pH at 0.2-2.5, the hydrochloric acid of appropriate concentration for the elution of alkali ions from waste cement and slag and the sodium bicarbonate of appropriate concentration for the precipitation of the alkali ions could be produced.

The main ingredients of the alkali ion-containing inorganic material except the alkali ion is silica and iron. When the alkali ion is eluted from the inorganic material using the hydrochloric acid aqueous solution according to the present invention, it is possible to selectively elute the alkali ion because the concentration of silica and iron in the eluted solution is very low as 2 ppm or lower. Therefore, it was possible to separate, through the alkali ion elution process using hydrochloric acid, a solution mainly containing the alkali ion from the silica- and iron-rich inorganic material. Through the reaction with sodium bicarbonate, the alkali ion-rich elution solution could be purified with a purity of 98.5 wt % or higher. It was possible to prepare high-purity calcium carbonate of 99.5 wt % or higher purity. In particular, by controlling the precipitation rate, it was possible to prepare the expensive precipitated calcium carbonate which has whiteness of 95 or higher and a particle size of 5 μm or smaller.

In addition, since the sodium chloride included in the filtrate discharged from the carbonate preparation reactor is purified and recycled, production cost can be saved and the purification process of removing impurities can be minimized.

What is claimed is:

1. A method for preparing a carbonate of an alkali ion, comprising:
an electrolysis process of producing hydrochloric acid (HCl) at an anode cell and producing sodium hydroxide (NaOH) at a cathode cell by electrolyzing a sodium chloride (NaCl) aqueous solution;
an elution process of selectively eluting an alkali ion from an inorganic material comprising the alkali ion using the hydrochloric acid (HCl) produced at the anode cell;
a sodium bicarbonate preparation process of converting the sodium hydroxide (NaOH) produced at the cathode cell to a sodium bicarbonate (NaHCO₃) quick precipitating agent by reacting with carbon dioxide (CO₂); and
a carbonate preparation process of preparing a carbonate of an alkali ion by reacting the sodium bicarbonate (NaHCO₃) with the alkali ion obtained in the elution process.

2. A method for preparing a carbonate of an alkali ion, comprising:
an electrolysis process of producing hydrochloric acid (HCl) at an anode cell by electrolyzing a sodium chloride (NaCl) aqueous solution and producing a sodium bicarbonate (NaHCO₃) quick precipitating agent at a cathode cell by reacting sodium hydroxide with carbon dioxide supplied from outside;
an elution process of selectively eluting an alkali ion from an inorganic material comprising the alkali ion using the hydrochloric acid (HCl) produced at the anode cell; and
a carbonate preparation process of preparing a carbonate of an alkali ion by reacting the sodium bicarbonate (NaHCO₃) produced at the cathode cell with the alkali ion obtained in the elution process.

3. The method for preparing a carbonate of an alkali ion according to claim 1 or 2, wherein the electrolysis process is performed under the condition where the concentration of the sodium chloride aqueous solution is maintained at 0.1-35 wt %.

4. The method for preparing a carbonate of an alkali ion according to claim 1 or 2, wherein, in the electrolysis process, a 0.1-35 wt % sodium chloride aqueous solution is supplied to a central cell installed for the supply of sodium chloride and 0-20 wt % sodium chloride is supplied to the cathode cell and the anode cell.

5. The method for preparing a carbonate of an alkali ion according to claim 1 or 2, wherein the electrolysis process is performed at 10-120° C. under the condition where the potential difference between the cathode and the anode is maintained at 0.5-1.5 V.

6. The method for preparing a carbonate of an alkali ion according to claim 1, wherein, in the electrolysis process, 0.1-2.0 M hydrochloric acid is produced at the anode cell and 0.1-2.0 M sodium hydroxide is produced at the cathode cell.

7. The method for preparing a carbonate of an alkali ion according to claim 1 or 2, wherein the anode cell is a gas diffusion electrode and generates a proton (H⁺) by oxidizing hydrogen (H₂).

8. The method for preparing a carbonate of an alkali ion according to claim 1 or 2, wherein the elution process is performed under the condition where the solid-to-liquid ratio (kg/L) of the inorganic material con comprising the alkali ion and the hydrochloric acid aqueous solution is maintained at 0.01-1.0.

9. The method for preparing a carbonate of an alkali ion according to claim 1 or 2, wherein the elution process is performed at 10-120° C. for 5-120 minutes.

10. The method for preparing a carbonate of an alkali ion according to claim 1 or 2, wherein the inorganic material con comprising the alkali ion supplied in the elution process is one or more selected from a group consisting of waste cement, slag, fly ash, feldspar (CaAl₂Si₂O₈), forsterite (Mg₂SiO₄), glauconite, ilmenite (FeTiO₃), listwanite (carbonated serpentinite), magnetite, olivine ((Mg,Fe)₂SiO₄), opoka, serpentine, serpentinite, talc (Mg₃Si₄Si₁₀(OH)₂) and wollastonite (CaSiO₃).

11. The method for preparing a carbonate of an alkali ion according to claim 1 or 2, wherein the carbonate preparation process is performed at 10-120° C. for 5-120 minutes.

12. The method for preparing a carbonate of an alkali ion according to claim 1 or 2, wherein a filtrate discharged from the carbonate preparation process is passed through a chelating ion-exchange resin membrane to obtain purified sodium chloride and the obtained sodium chloride is recycled to the electrolysis process.

13. A reaction system for preparing a carbonate of an alkali ion, comprising:
an electrolysis reactor 10 which produces hydrochloric acid (HCl) and sodium hydroxide (NaOH) by electrolyzing sodium chloride (NaCl);
an elution reactor 20 which selectively elutes an alkali ion from an inorganic material comprising the alkali ion using the hydrochloric acid (HCl) supplied from the electrolysis reactor 10;
a sodium bicarbonate preparation reactor 30 which produces sodium bicarbonate (NaHCO₃) by reacting the sodium hydroxide (NaOH) and the carbon dioxide (CO₂) supplied from the electrolysis reactor 10; and
a carbonate preparation reactor 40 which produces a carbonate of an alkali ion by reacting the alkali ion supplied from the elution reactor 20 with the sodium bicarbonate supplied from the sodium bicarbonate preparation reactor 30.

14. A reaction system for preparing a carbonate of an alkali ion, comprising:
an electrolysis reactor 10 which produces hydrochloric acid (HCl) and sodium hydroxide (NaOH) by electrolyzing sodium chloride (NaCl);
an elution reactor 20 which selectively elutes an alkali ion from an inorganic material comprising the alkali ion using the hydrochloric acid (HCl) supplied from the electrolysis reactor 10; and
a carbonate preparation reactor 40 which converts the sodium hydroxide (NaOH) supplied from the electrolysis reactor 10 to sodium bicarbonate (NaHCO₃) by reacting with carbon dioxide (CO₂) and produces a carbonate of an alkali ion by reacting the sodium bicarbonate (NaHCO₃) with the alkali ion supplied from the elution reactor 20.

15. The reaction system for preparing a carbonate of an alkali ion according to claim 13 or 14, which further comprises a sodium chloride purifier 50 which separates and purifies sodium chloride from a filtrate discharged from the carbonate preparation reactor 40.

16. The reaction system for preparing a carbonate of an alkali ion according to claim 13 or 14, wherein the electrolysis reactor 10 comprises an anode cell, a central cell for supplying a sodium chloride aqueous solution and a cathode cell in sequence, has an anion exchange membrane equipped between the anode cell and the central cell so that chloride anion can migrate therethrough and has a cation exchange membrane equipped between the cathode cell and the central cell so that sodium cation can migrate therethrough.
